(19) United States
(12) Patent Application Publication
(10) Pub. No.: US 2013/0182230 A1
(43) Pub. Date: Jul. 18, 2013

(54) PRISM SYSTEM AND METHOD THEREOF FOR ELIMINATING COLOR ABERRATION

(71) Applicants: Sheng-Han Lin, Hsinchu City (TW); Jui-Wen Pan, Hsinchu City (TW); Hsiang-Hua Wang, Hsinchu City (TW)

(72) Inventors: Sheng-Han Lin, Hsinchu City (TW); Jui-Wen Pan, Hsinchu City (TW); Hsiang-Hua Wang, Hsinchu City (TW)

(73) Assignee: NATIONAL CHIAO TUNG UNIVERSITY, Hsinchu City (TW)

(21) Appl. No.: 13/546,299

(22) Filed: Jul. 11, 2012

(30) Foreign Application Priority Data
Jan. 13, 2012 (TW) 101101354

(51) Int. Cl. G03B 21/28

(52) U.S. Cl. 353/81; 353/121

(57) ABSTRACT

A prism system and method for eliminating color aberration in an illumination system of a micro projector is disclosed. A light beam enters into a first prism through a light incident surface thereof and is further emitted through a light-emitting surface of the first prism. The light beam then enters into a second prism through a first interface thereof, passes through a second interface of the second prism and reaches a digital micromirror device (DMD). The light beam is reflected by the DMD so as to pass through the second interface and reach the first interface. The light beam is totally reflected by the first interface so as to be emitted through a third interface of the second prism. Therefore, the invention eliminates lateral color aberration that occurs in an active area of the DMD, reduces costs of illumination equipment and achieves a preferred projection effect.

### BACKGROUND OF THE INVENTION

1. Field of the Invention

The present invention relates to prism systems and methods for eliminating lateral color aberration, and, more particularly, to a prism system and method for eliminating lateral color aberration of an illumination system.

2. Description of Related Art

Light emitting diodes (LEDs) have been widely applied in digital light processing (DLP) projectors and Liquid Crystal on Silicon (LCoS) projectors due to their advantages of low energy consumption and high conversion efficiency.

In DLP micro projectors, LED modules can replace conventional ultra-high pressure (UHP) lamps to serve as light sources, thereby shortening the response time and eliminating the need for color wheels that are otherwise required in the prior art for creating differently colored lights. In general, red, green and blue LED modules are provided separately in a light source module. When such an RGB LED light source is applied in a micro projector, color uniformity issues may occur at the center and corner portions of a projection screen, including lateral color aberration occurring at the corners of the active area of a digital micromirror device (DMD) and uneven color uniformity occurring at the center of the DMD active area. Conventionally, a cemented lens is applied in an illumination system so as to reduce lateral color aberration occurring at the corners of the DMD active area.

FIGS. 1A and 1B are cross-sectional views showing generation of color aberration by a single lens, and a conventional doublet lens structure used for eliminating color aberration, respectively. Referring to FIG. 1A, when lights of different wavelengths are incident on a lens 100, the lights of different wavelengths have different refractive angles due to their different refractive indices, thereby generating color aberration. As such, red and blue colors are separately displayed on the projection screen. Accordingly, a doublet lens is provided to overcome the drawback. Referring to FIG. 1B, a crown glass convex lens 120 and a flint glass concave lens 110 are combined to eliminate color aberration based on their different dispersion coefficients. Generally, the lenses are ground and manufactured together and assembled through an adhesive.

FIG. 2 is a cross-sectional view showing a light path in a conventional micro projector 1. Referring to FIG. 2, light emitted from a light source module 10 (including blue, red and green light sources and a dichroic filter 101) passes through a condenser 11, a light pipe 12 and a relay system 13 having a doublet lens for eliminating color aberration, and is reflected by a DMD 15 and a total internal reflection (TIR) prism group 14 so as to enter into a projection system 16. In other words, the relay system 13 and the TIR prism group 14 are combined to eliminate lateral color aberration occurring at the corners of the active area of the DMD 15. However, since the doublet lens is usually made of glass, it results in high cost for the illumination system.

Further, the color uniformity at the center of the active area of the DMD can be adjusted by changing the length of the light pipe. That is, the color uniformity can be controlled through the length of the light pipe. The longer the light pipe, the better the color uniformity is. On the other hand, a longer light pipe undesirably results in an increased size of the projector and increased loss of light energy in the light pipe. Consequently, finding a way to achieve a balance between color uniformity and miniaturization of the projector is quite important in the field.

Therefore, there is a need to provide a prism system and method so as to overcome the above-described drawbacks.

### SUMMARY OF THE INVENTION

Accordingly, an object of the present invention is to provide a prism system and method in which two prisms with appropriate material properties are disposed so as to eliminate lateral color aberration occurring at the corners of the active area of a DMD.

Another object of the present invention is to provide a prism system and method in which the length of a light pipe is adjusted so as to improve the color uniformity at the center of the DMD active area.

In order to achieve the above and other objectives, the present invention provides a prism system for eliminating color aberration in an illumination system of a micro projector, which comprises: a first prism having a light incident surface for entry of a light beam thereinto and a light-emitting surface for emitting the light beam therefrom; a second prism disposed adjacent to the first prism and having a first interface corresponding in position to the light-emitting surface of the first prism and a second interface and a third interface adjacent to the first interface; and a digital micromirror device (DMD) disposed adjacent to the second prism and corresponding in position to the second interface of the second prism, wherein, when the light beam enters into the second prism and passes through the second interface and reaches the DMD, the light beam is reflected by the DMD so as to pass through the second interface and reach the first interface, and further, the light beam is totally reflected by the first interface so as to be emitted through the third interface of the second prism.

In an embodiment, the first and second prisms are made of different materials, for example, different glass or plastic materials.

In another embodiment, the light beam comes from a light pipe that is used for controlling the illumination uniformity and color uniformity of a light source emitted from the illumination system. Further, the ratio between the length of the light pipe and the diagonal length of the cross section of the light pipe is greater than 2.547.

The present invention further provides a method for eliminating color aberration by using a prism system having a first prism, a second prism and a DMD. The method comprises the steps of: (1) when a light beam enters into the first prism through a light incident surface thereof, emitting the light beam through a light-emitting surface of the first prism so as for the light beam to enter into the second prism through a first interface of the second prism corresponding in position to the light-emitting surface of the first prism and further pass through a second interface of the second prism so as to reach the DMD; (2) reflecting the light beam through the DMD so as for the light beam to pass through the second interface and reach the first interface of the second prism; and (3) totally reflecting the light beam through the first interface so as to emit the light beam through a third interface of the second prism.

In an embodiment, the light beam comes from a light pipe, and the ratio between the length of the light pipe and the diagonal length of the cross section of the light pipe is greater than 2.547.

Therefore, the present invention provides a prism system made of two different materials so as for the light beam to pass therethrough, thereby effectively reducing color aberration. Furthermore, when the ratio between the length of the light pipe and the diagonal length of the cross section of the light pipe is set to be greater than 2.547, the present invention obtains an optimal balance point between the illumination uniformity, the color uniformity and the length of the light pipe. As such, the present invention not only overcomes the conventional drawback of lateral color aberration, but also reduces costs of illumination equipment and achieves a preferred projection effect for a micro projector.

### BRIEF DESCRIPTION OF DRAWINGS

FIGS. 1A and 1B are, respectively, cross-sectional views showing generation of color aberration by a single lens and a conventional doublet lens structure for eliminating color aberration;

FIG. 2 is a cross-sectional view showing a light path in a conventional micro projector;

FIG. 3 is a cross-sectional view showing a prism system for eliminating lateral color aberration according to the present invention;

FIG. 4 is a perspective view showing a light pipe of the present invention;

FIG. 5 is a cross-sectional view showing a micro projector having a prism system of the present invention; and

FIG. 6 is a flow diagram showing a method for eliminating lateral color aberration according to the present invention.

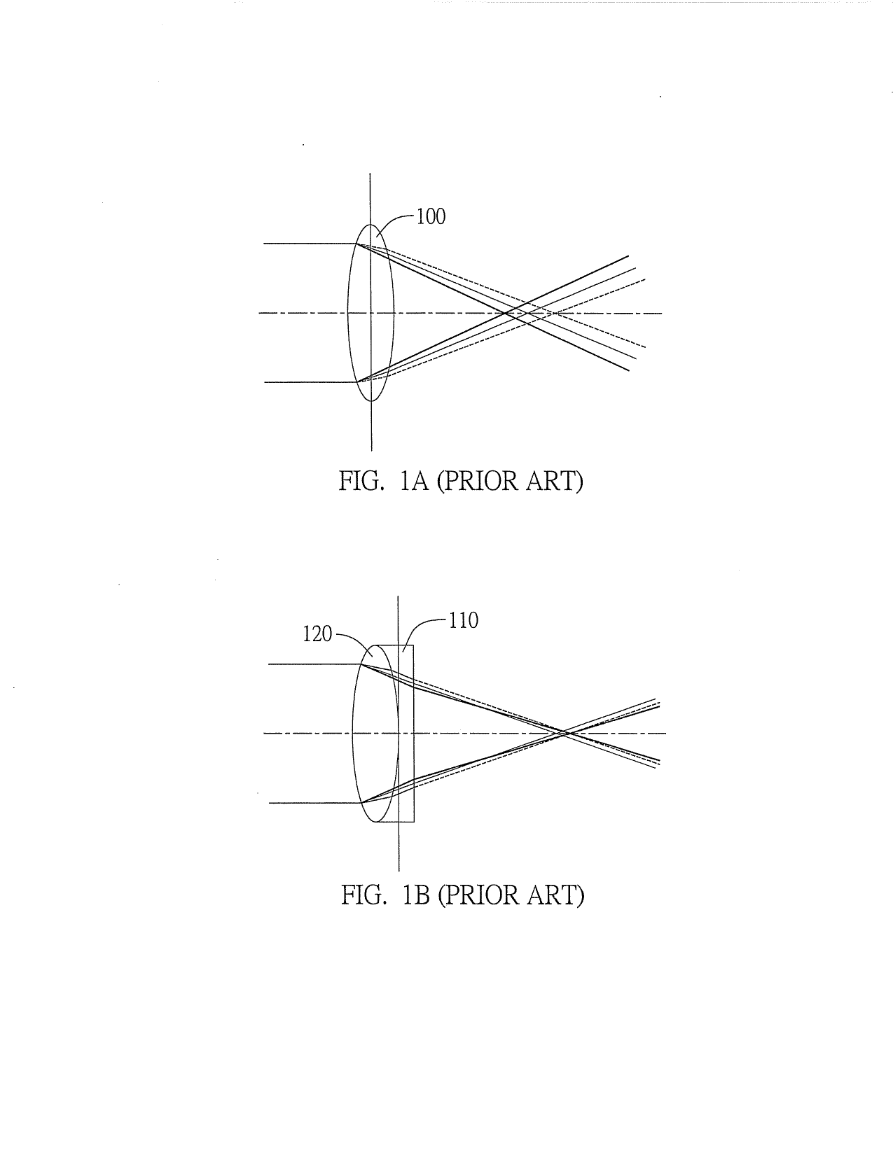

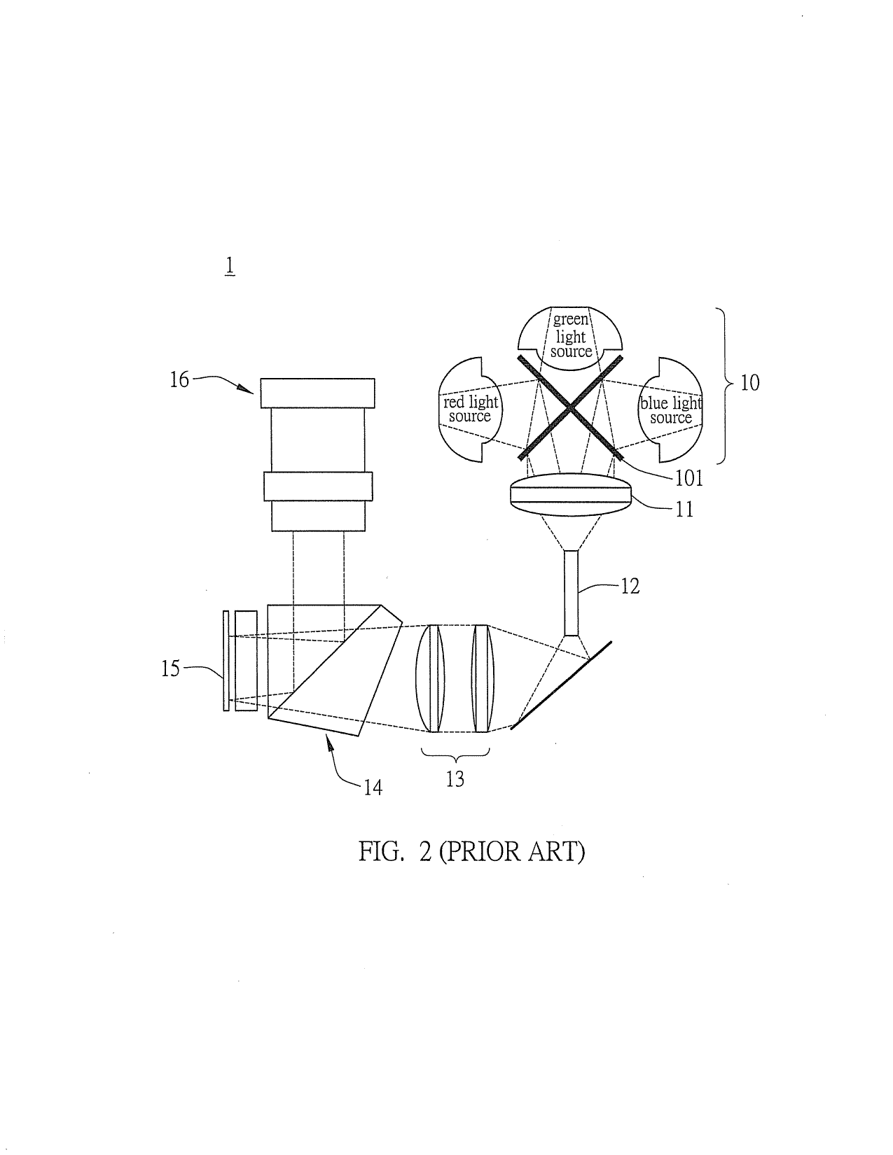

### DETAILED DESCRIPTION OF PREFERRED EMBODIMENTS

The following illustrative embodiments are provided to illustrate the disclosure of the present invention and its advantages, these and other advantages and effects being apparent to those in the art after reading this specification.

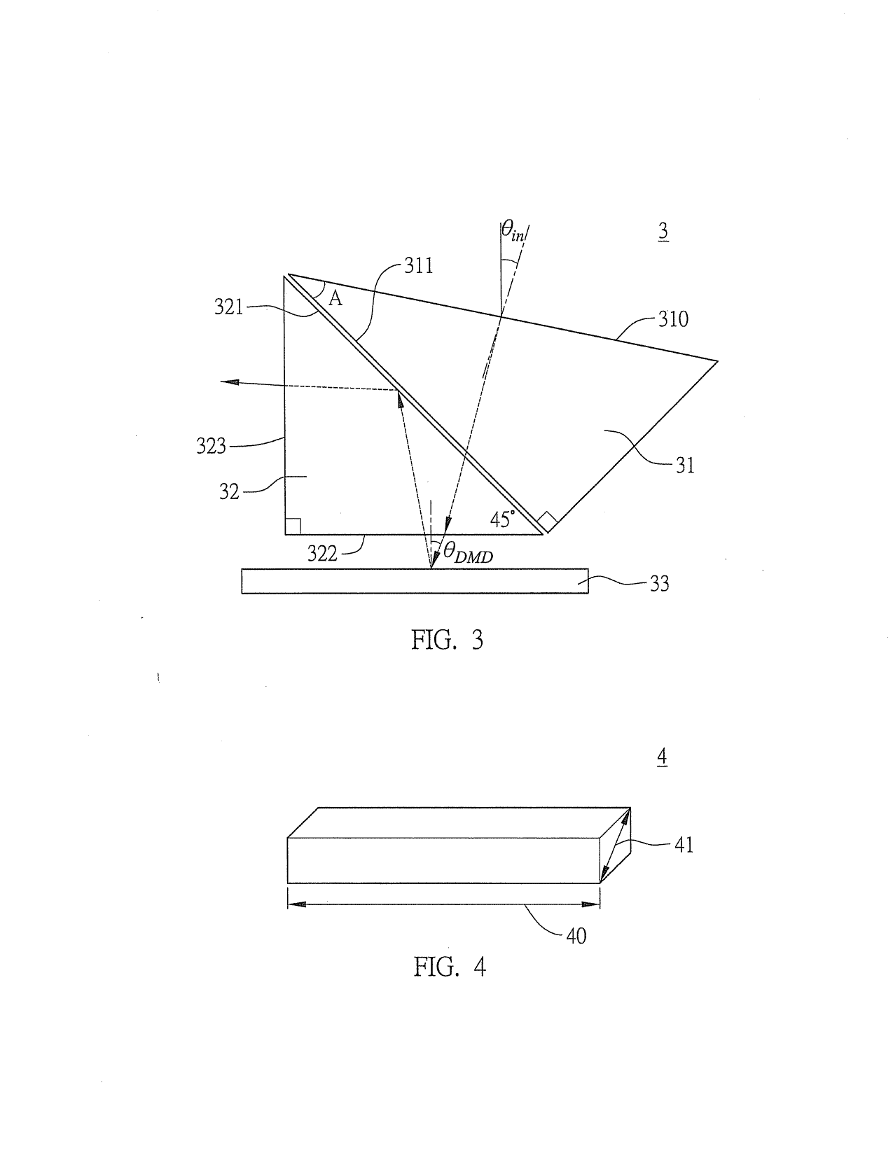

FIG. 3 is a schematic view showing a prism system 3 for eliminating lateral color aberration according to the present invention. FIG. 3 also illustrates the direction and path of movement of a light beam in the prism system 3. The prism system 3 can be applied in an illumination system of a micro projector for eliminating lateral color aberration caused by the illumination system. The prism system 3 has a first prism 31, a second prism 32 and a DMD 33.

The first prism 31 has a light incident surface 310 and a light-emitting surface 311 so as for a light beam to enter into the first prism 31 through the light incident surface 310 and be emitted out through the light-emitting surface 311. In particular, the first prism 31 has a refractive index of n₁ and a dispersion coefficient (or Abbe number) of V_{d1}. When the light beam enters into the first prism 31, the light beam has an incident angle of θᵢₙ with respect to the light incident surface 310.

The second prism 32 is disposed adjacent to the first prism 31 and made of a material different from the first prism 31. The second prism 32 has a first interface 321 corresponding in position to the light-emitting surface 311 of the first prism 31 and a second interface 322 and a third interface 323 adjacent to the first interface 321. In particular, the second prism 32 has a refractive index of n₂ and a dispersion coefficient of V_{d2}. There is a gap between the light-emitting surface 311 of the first prism 31 and the first interface 321 of the second prism 32. That is, the prism system 3 is made up of two prisms separated from each other, i.e., the first prism 31 and the second prism 32.

Further, the DMD 33 is disposed adjacent to the second prism 32 and corresponding in position to the second interface 322. The DMD 33 is made up of a plurality of micromirrors. Each of the micromirrors controls a corresponding one of the pixels of a projection image. Through deflection of the micromirrors, the incident light can be reflected at a desired angle. For example, an on-off switch can be provided. If the switch is turned on, the light beam reflected by the micromirrors can completely enter into the projection lens. Otherwise, if the switch is turned off, the micromirrors are deflected to a certain angle such that the light beam cannot enter into a range that is receivable by the projection lens. Consequently, no image (light spot) is generated on the display screen. Therefore, the DMD 33 is an important component for projection. Since the DMD 33 is well known in the prior art, detailed description thereof is omitted herein. Therefore, when a light beam is emitted through the light-emitting surface 311 of the first prism 31 and enters into the second prism 32, the light beam passes through the second interface 322 so as to reach the DMD 33. Further, the light beam is reflected by the DMD 33 so as to pass through the second interface 322 of the second prism 32 and reach the first interface 321 of the second prism 32. Then, the light beam is totally reflected by the first interface 321 so as to be emitted through the third interface 323 of the second prism 32. Furthermore, the light beam is incident on an active area of the DMD 33 through the second interface 322. The active area refers to an area that is responsive to the light beam.

In the present embodiment, the first prism 31 and the second prism 32 are made of different materials, for example, different plastic materials. It should be noted that the prisms can be made of plastic or glass. Since a plastic prism is cheaper than a glass prism, plastic prisms are used in the present embodiment to reduce the cost. In the present embodiment, the first prism 31 and the second prism 32 and a TIR prism are integrated together to eliminate lateral color aberration occurring at the corners of the active area of the DMD. That is, the light beam must pass through two prisms made of different materials before entering into the active area of the DMD. The two prisms have different refractive indices and dispersion coefficients such that their color aberrations can cancel each other, for example, by adjusting the focus positions of blue and red light.

Furthermore, as described above, the first prism 31 has the refractive index of n₁ and the dispersion coefficient of V_{d1}, and the second prism 32 has the refractive index of n₂ and the dispersion coefficient of V_{d2}. To make the prisms have a color aberration elimination capability, V_{d1} should be less than V_{d2}. But there is no limitation on the refractive indices of the first prism 31 and the second prism 32. That is, n₁ can be greater than or less than n₂ according to the materials of the two prisms.

Now, the relationship between the angles of the light beam with respect to the first and second prisms 31, 32 and the color aberration elimination effect is described as follows. The light beam has an incident angle of θᵢₙ with respect to the light incident surface 310 of the first prism 31, the first prism 31 has an angle A between the light incident surface 310 and the light-emitting surface 311, the light beam enters into the DMD 33 with an incident angle of θ_{DMD}, and the deflection angle of the micromirrors of the DMD is ±θₘ. To eliminate color aberration, the incident angles θᵢₙ and θ_{DMD} should meet the following equation (1):

$${θ}_{i n} = {n}_{a} sin \{ {sin}^{- 1} [ \frac{{n}_{1}}{{n}_{2}} sin ( 45 ° - {sin}^{- 1} \frac{sin {θ}_{DMD}}{{n}_{2}} ) ] - A \} , \\ 2 {θ}_{m} - 5 \leq {θ}_{DMD} \leq 2 {θ}_{m} + 5 \qquad ( 1 )$$

It should be noted that if θₘ=12°, θ_{DMD} is between 19° and 29°. In the present embodiment, if the projection lens has a fixed design, the second prism 32 (isosceles right triangle) can be made of N-BK7 and the first prism 31 can be made of N-SK16. Under the above-described condition, the light beam preferably enters into the DMD 33 with the incident angle θ_{DMD} of 26.5°.

Further, the illumination system of the projector has a homogenizer, a relay system and a TIR prism. The above-described two prisms are used to reduce lateral aberration occurring at the corners of the active area of the DMD, while the color uniformity at the center of the active area of the DMD can be controlled through the homogenizer. In the design of a conventional homogenizer, a micro lens array or a light pipe can be used. However, the micro lens array divides the incident light beam into a plurality of cell beams, each of which generates a lateral aberration on the DMD, and the above-described prism system cannot eliminate so many lateral color aberrations. Therefore, a light pipe is used in the present invention to control the color uniformity.

In another embodiment, the light beam comes from a light pipe of the micro projector. Therein, the light beam is used to control the illumination uniformity and color uniformity of the light source emitted from the illumination system. FIG. 4 is a perspective view showing a light pipe 4 of the present invention. The light pipe 4 is made up of four silver-plated mirrors. No matter what the shape of the light pipe 4, the area projected on the DMD chip by the light emitted from the light pipe 4 must be greater than the active area of the DMD. Therefore, in order to provide a preferred color uniformity, the ratio of the luminous flux of the DMD active area to the luminous flux of the overall DMD chip, the average value of Δu′v′ (u′ and v′ are coordinates of the current outputted color) as an indicator of the color uniformity, the luminous uniformity of the DMD active area and the optical efficiency of the light pipe 4 (to avoid too much light energy loss in the light pipe 4) are monitored such that an optimal balance point is obtained when the ratio of the length 40 of the light pipe 4 to the diagonal length 41 of the cross section of the light pipe 4 is greater than 2.547. Therefore, by appropriately adjusting the length of the light pipe, the present invention can control the color uniformity while meeting the miniaturization requirement.

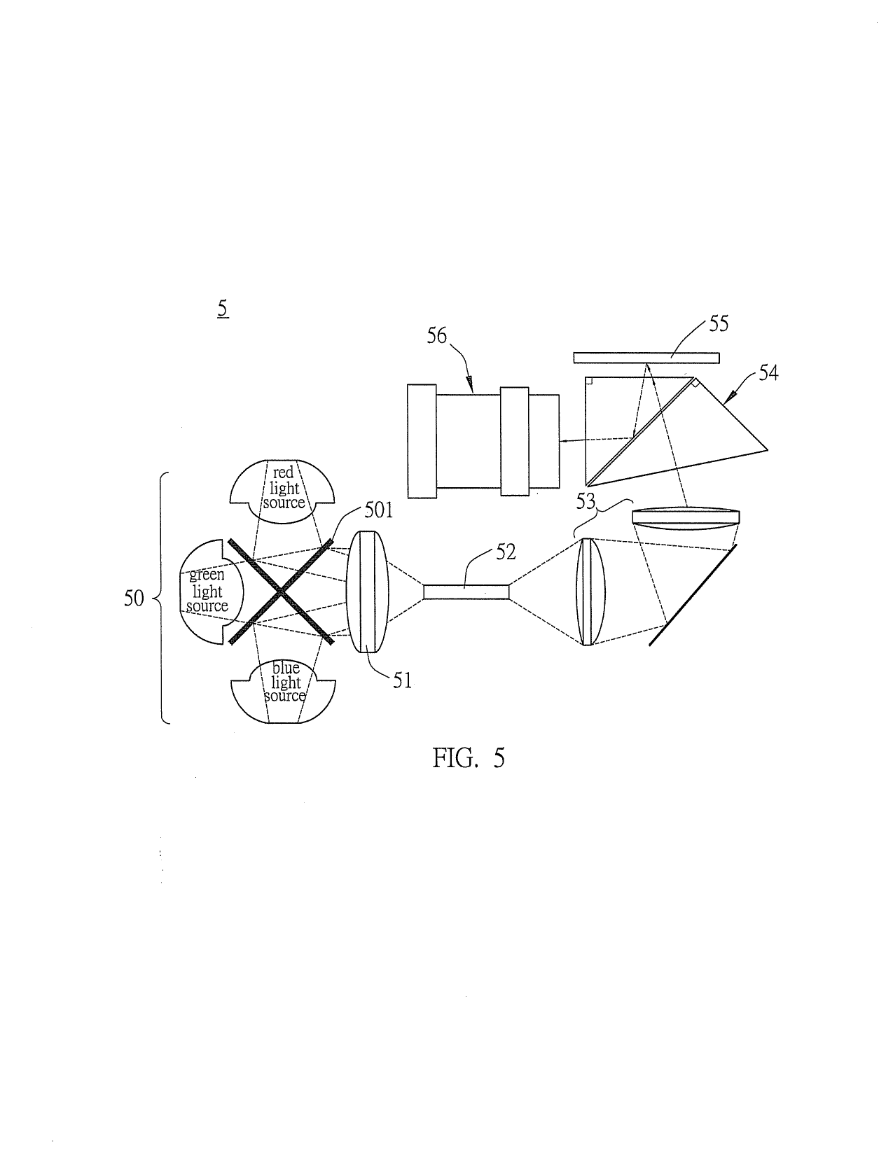

FIG. 5 shows an example of a micro projector having the above-described prism system for eliminating color aberration.

Referring to FIG. 5 in combination with FIGS. 3 and 4, the micro projector 5 can be divided into two portions: an illumination system and a projection system. Therein, the illumination system has red, blue and green LED light source modules 50, two groups of dichroic filters 501, a condenser 51, a light pipe 52, a relay system 53, a prism system 54 and a DMD 55. The projection system 56 is a conventional element having projection function. In particular, red, blue and green lights emitted from the LED light source modules 50, respectively, are mixed into a white light beam through the light pipe 52. Then, the light beam is converted and geometrically scaled through the relay system 53, passes through the prism system 54 and the DMD 54 so as to be projected on the projection system 56. In order to clarify the path of the light beam in the prism system 54, only a single light beam is shown in the drawing.

The relay system 53 covers a range from the outlet of the light pipe 52 to the plane of the DMD 55 and is used for converting light emitted from the outlet of the light pipe 52 into a light beam that meets the requirement of the projection system and meanwhile maintaining the uniformity of the light emitted from the light pipe 52 within an acceptable range.

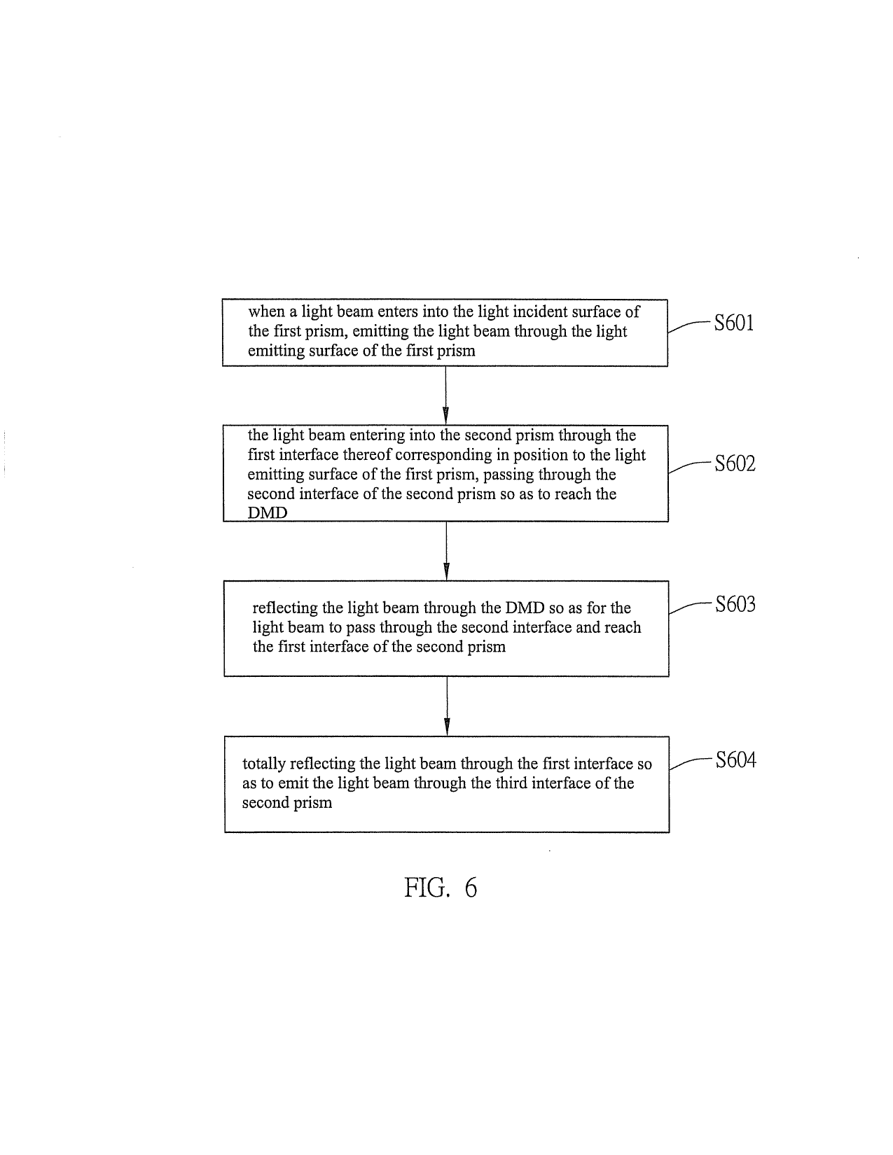

FIG. 6 is a flow diagram showing a method for eliminating lateral color aberration by using the prism system having the first prism, the second prism and the DMD as shown in FIG. 3. Referring to FIG. 6, at step S601, when a light beam enters into the light incident surface of the first prism, the light beam is emitted through the light-emitting surface of the first prism. Then, the process goes to step S602.

At step S602, the light beam enters into the second prism through the first interface corresponding in position to the light-emitting surface of the first prism and passes through the second prism so as to reach the DMD. Then, the process goes to step S603.

At step S603, the light beam is reflected by the DMD so as to pass through the second interface and reach the first interface of the second prism. Then, the process goes to step S604.

At step S604, the light beam is totally reflected by the first interface so as to be emitted through the third interface of the second prism. By making the light beam pass through the first and second prisms of different materials, the color aberrations of the two prisms can cancel each other. As such, the present invention successfully eliminates color aberration.

In an embodiment, the first prism and the second prism are made of different materials. In a preferred embodiment, the first and second prisms are made of different plastic materials so as to reduce the fabrication cost. But it should be noted that the present invention is not limited thereto.

The first prism has a dispersion coefficient of V_{d1} and a refractive index of n₁, and the second prism has a dispersion coefficient of V_{d2} and a refractive index of n₂. Therein, the dispersion coefficient V_{d1} is less than V_{d2}, and there is no limitation on the refractive indices n₁ and n₂.

In another embodiment, the light beam comes from a light pipe, and the ratio of the length of the light pipe to the diagonal length of the cross section of the light pipe is greater than 2.547 so as to achieve an optimal color uniformity while taking into account the projection imaging effect and the size of the micro projector that are related to the length of the light pipe.

Therefore, the present invention provides a prism system made of two different materials so as for the light beam to pass therethrough, thereby effectively reducing color aberration. Furthermore, when the ratio between the length of the light pipe and the diagonal length of the cross section of the light pipe is set to be within a specific range, the present invention achieves optimal color uniformity. As such, the present invention not only overcomes the conventional drawback of lateral color aberration, but also reduces costs of illumination equipment and achieves a preferred projection effect for a micro projector.

The above-described descriptions of the detailed embodiments are to illustrate the preferred implementation according to the present invention, and are not intended to limit the scope of the present invention. Accordingly, many modifications and variations completed by those with ordinary skill in the art will fall within the scope of present invention as defined by the appended claims.

What is claimed is:

1. A prism system for eliminating color aberration in an illumination system of a micro projector, comprising:
a first prism having a light incident surface for entry of a light beam thereinto and a light-emitting surface for emitting the light beam therefrom;
a second prism disposed adjacent to the first prism and having a first interface corresponding in position to the light-emitting surface of the first prism and a second interface and a third interface adjacent to the first interface; and
a digital micromirror device (DMD) disposed adjacent to the second prism and corresponding in position to the second interface of the second prism, wherein the light beam, after entering into the second prism, passing through the second interface and reaching the DMD, is reflected by the DMD so as to pass through the second interface and reach the first interface, and to be totally reflected by the first interface so as to be emitted through the third interface of the second prism.

2. The prism system of claim 1, wherein the first prism and the second prism are made of different materials.

3. The prism system of claim 1, wherein the first prism has a first dispersion coefficient less than a second dispersion coefficient of the second prism.

4. The prism system of claim 1, wherein the first prism has a first refractive index of n₁ and the second prism has a second refractive index of n₂, the light beam has an incident angle of θᵢₙ with respect to the light incident surface of the first prism and is incident on the DMD with an incident angle of θ_{DMD}, the first prism has an angle of A between the light incident surface and the light-emitting surface, each micromirror of the DMD has a deflection angle of ±θₘ, and the incident angle θᵢₙ and the incident angle θ_{DMD} meet the following equation:
$${θ}_{i n} = {n}_{1} sin \{ {sin}^{- 1} [ \frac{{n}_{1}}{{n}_{2}} sin ( 45 ° - {sin}^{- 1} \frac{sin {θ}_{DMD}}{{n}_{2}} ) ] - A \} , \\ 2 {θ}_{m} - 5 \leq {θ}_{DMD} \leq 2 {θ}_{m} + 5.$$

5. The prism system of claim 1, wherein the light beam comes from a light pipe that is used for controlling the illumination uniformity and color uniformity of a light source emitted from the illumination system.

6. The prism system of claim 5, wherein the ratio between the length of the light pipe and the diagonal length of the cross section of the light pipe is greater than 2.547.

7. A method for eliminating color aberration by using a prism system having a first prism, a second prism and a DMD, the method comprising the steps of:
(1) when a light beam enters into the first prism through a light incident surface thereof, emitting the light beam through a light-emitting surface of the first prism so as for the light beam to enter into the second prism through a first interface of the second prism corresponding in position to the light-emitting surface of the first prism and further pass through a second interface of the second prism so as to reach the DMD;
(2) reflecting the light beam through the DMD so as for the light beam to pass through the second interface and reach the first interface of the second prism; and
(3) totally reflecting the light beam through the first interface so as to emit the light beam through a third interface of the second prism.

8. The method of claim 7, wherein the light beam comes from a light pipe, wherein the ratio between the length of the light pipe and the diagonal length of the cross section of the light pipe is greater than 2.547.

9. The method of claim 7, wherein the first prism and the second prism are made of different materials.

10. The method of claim 7, wherein the first prism has a first dispersion coefficient less than a second dispersion coefficient of the second prism.
